(19) United States
(12) Patent Application Publication
(10) Pub. No.: US 2004/0264842 A1
(43) Pub. Date: Dec. 30, 2004

(54) Measuring coupling characteristics of optical devices

(76) Inventors: Tsung-Ein Tsai, San Jose, CA (US); John N. Sweetser, San Jose, CA (US); Anders Grunnet-Jepsen, San Jose, CA (US); Ping Qu, San Jose, CA (US); Everett Wang, San Jose, CA (US); Yi Ding, Milpitas, CA (US)

Correspondence Address: Timothy N. Trop, TROP, PRUNER & HU, P.C., STE 100, 8554 KATY FWY, HOUSTON, TX, 77024-1841, US

(21) Appl. No.: 10/608,726

(22) Filed: Jun. 27, 2003

(51) Int. Cl. G02B 6/35; G02B 6/27

(52) U.S. Cl. 385/16; 385/11

(57) ABSTRACT

The coupling properties of an optical device having at least two inputs and two outputs may be more accurately measured by simultaneously measuring the optical transmission through all outputs for light coupled to each input to the device. An optical switch may be used to selectively couple the light to each of the device inputs. This removes the need to remove the light source from one input and to reconnect it to another input. By proper processing of the measured optical transmission corresponding to each input, an accurate and precise value for the transfer function, including polarization properties, of the device may be obtained independent of the insertion losses in the system.

### BACKGROUND

This invention relates generally to determining coupling characteristics of optical devices.

A 2×2 optical device is an optical device that receives at least two inputs and provides at least two outputs. Examples of such devices include couplers, and Michelson and Mach-Zehnder interferometers.

It may be desired to measure the effective coupling coefficient of optical devices. The coupling coefficient indicates how much of the input light is coupled to the output port. The coupling coefficient may be measured by providing a light source to a first input port of the 2×2 optical device and a detector to a first output port of the 2×2 optical device. Thus, the first input and output ports are tested and then the light source and detector are decoupled from those ports and recoupled to the second input and output ports of the 2×2 optical device.

In traditional measurement systems, after measuring the output power at one of two output ports, the power detector is disconnected and reconnected to the other output port. During this process, the input power can be changed slightly due to a power fluctuation that depends on the light source used. Since connectors are now connected and reconnected, the insertion loss may vary as a result of the mechanical disturbance arising from changing the connectors. This insertion loss variation, as well as other sources of loss in the measurement system, may limit the accuracy of the coupling coefficient measurement. For example, when the coupling ratio is estimated from the ratio of the two output powers, variations in the losses of the two output connectors contribute to measurement error. The power fluctuation can be avoided using two-detector measurement systems; however, the variation in connector losses still exists.

Thus, there is a need for better ways to measure coupling characteristics of optical devices.

### BRIEF DESCRIPTION OF THE DRAWINGS

FIG. 1 is a schematic depiction of one embodiment of the present invention;

FIG. 2 is a depiction of coupling ratio versus wavelength for a prototype embodiment of the present invention;

FIG. 3 is a depiction of one embodiment of the present invention illustrating the contributions to measurement error;

FIG. 4 is a schematic depiction of another embodiment of the present invention; and

FIG. 5 is a depiction of coupling ratio versus wavelength.

### DETAILED DESCRIPTION

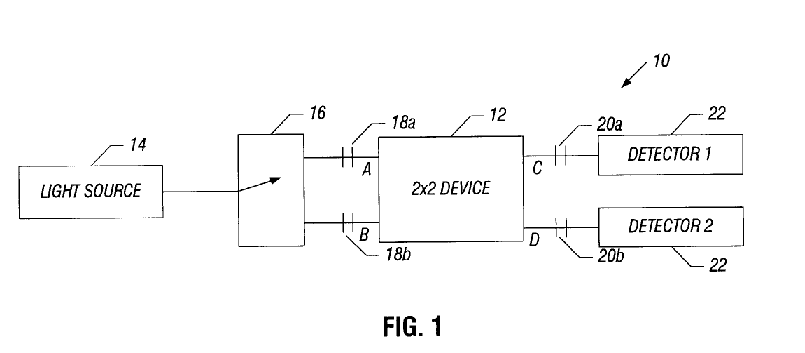

Referring to FIG. 1, a light source 14 may be coupled to a 2×2 optical device 12 through a 1×2 optical switch 16. Connectors 18a and 18b may be provided to couple the optical switch 16 to the 2×2 optical device 12. However, once the connections are made between the switch 16 and the device 12, they need not be undone until after the completion of the test.

Similarly, a pair of detectors 22 may be coupled by connectors 20a and 20b to the outputs of the 2×2 optical device 12. Again, it is not necessary to disconnect the detector during the course of any testing.

The arrangement shown in FIG. 1 may reduce measurement errors caused either by light source power fluctuations or by the variation of insertion losses. In some embodiments, input power variation and connector loss statistical errors may be reduced, measurement repeatability may be increased, and data may be obtained more independently of variation in insertion losses. In some embodiments, this may result in an order of magnitude decrease in measurement errors.

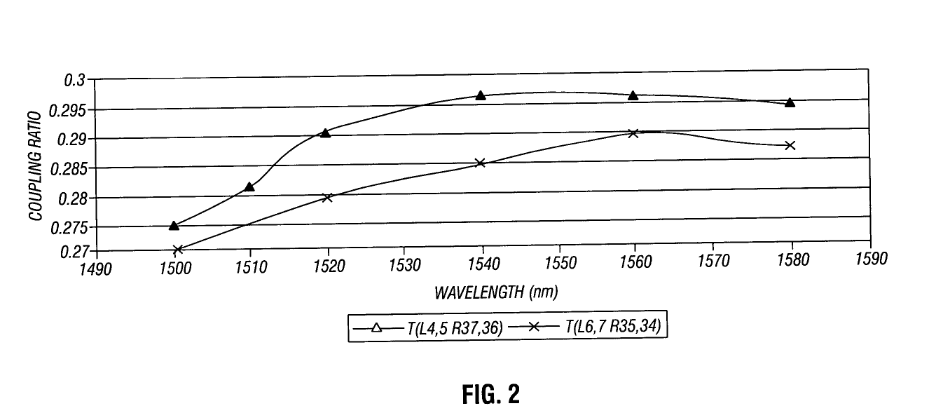

For example, referring to FIG. 2, a typical standard deviation of ±0.013 is obtained for the coupling ratio data for couplers measured with traditional systems. However, using the system shown in FIG. 1, the standard deviation in repeated coupling ratio measurements on the same device is reduced to ±0.0015 in one embodiment. Thus, the two devices shown in FIG. 2 would be practically indistinguishable using a traditional measurement, but are easily distinguished using the method disclosed here.

The coupling ratio of a 2×2 loss-less device can be parameterized with an effective cross-transfer (from input A to output D or from input B to output C of the device 12 in FIG. 1) coupling ratio T. For loss-less coupling devices, the direct-transfer (from input A to output C or from input B to output D) coupling ratio is 1-T.

The fraction of optical power transmitted to the coupling region (or from the coupling region to) port i can be parameterized by Tᵢ (where i is either the input port A or B or the output port C or D), the overall fraction of power transferred from:

input A to output C: T_{AC}T_{A}(1-T)T_{C} input A to output D: T_{AD}=T_{A}TT_{D}

input B to output C: T_{BC}=T_{B}TT_{C} input B to output D: T_{BD}=T_{B}(1-T)T_{D}

If there are no mechanical disturbances and no input power fluctuations during the input and output power measurements, then Tᵢ's (i=A, B, C, and D) are constant. Tᵢ includes the input/output insertion losses and waveguide propagation losses, which can be different for different polarization states of light. It can then be shown that:

T=1/(1+((T_{AC}/T_{AD})/(T_{BC}/T_{BD}))^{0.5}) (1)

It turns out that T calculated from Eq. (1) is independent of the overall input insertion losses Tᵢ(i=A, B, C, and D) so long as they are not changed during each measurement.

For 2×2 devices, it is convenient to define a parameter Δ=10×log((1-T)/T), which measures the deviation from the ideal 3-dB (50/50) coupler of T=0.5 (Δ=0). For output powers, P_{AC}, P_{AD}, P_{BC}, and P_{BD} measured in dBm, Δ is then:

Δ=0.5×(P_{AC}(dBm)−P_{AD}(dBm)−(P_{BC}(dBm)−P_{BD}(dBm)) (2)

In essence, four measurements, rather than two, are made. And coupling ratio T is calculated using Eq. (1) or Eq. (2). Using this algorithm and method, the variations in connector losses (related to Tᵢ's) may be theoretically eliminated since they do not appear in these equations.

In this two-detector measurement system, two power detectors 22, and a 1 by 2 optical switch 16 are used. This measurement system can reduce errors associated with power fluctuation and those associated with mechanical disturbance or with unknown losses in the device or measurement system. The power fluctuation errors in this measurement system are reduced since the two output powers are measured simultaneously using two power detectors 22 and their ratio is used in Eq. (1). The mechanical disturbance is reduced by using two detectors 22 and a 1×2 optical switch 16. Mechanical disturbance may be reduced during the four Tᵢⱼ(ij=AC, AD, BC, and BD) measurements since no connections need be disconnected and reconnected (connector change for switching input light from port A to port B using 1×2 optical switch has minimum mechanical disturbance). While improving the ease of the measurement, the use of a 1×2 switch is not necessary in order to realize the benefits of the improved methods described here. Advantageously, the losses in the system, described by Tᵢ, do not change during the course of a single measurement so that their effect is reduced or eliminated by the procedure described above and summarized in Eqs. (1) and (2). Therefore, it is acceptable to physically connect and disconnect the two inputs between the two measurements described above. Thus, in cases where a switch is not available, manual connections of the inputs can be used with no loss in accuracy.

The data obtained using these techniques demonstrate that the illustrated two-detector-measurement system may reduce measurement errors by an order of magnitude in some cases. Since T estimated from Eq. (1) is independent of the power of input light and the overall insertion losses of the two input and two output ports, any light source can be used without demanding high quality optical connectors.

Since the powers measured on the two output ports for light input to a given input port always appear as a ratio in Eq. (1), the two power detectors 22 need not necessarily have the same power calibration as long as their optical responses are in the linear region. Lastly, this measurement method can be extended for measuring the coupling coefficients of n×n optical devices using 1×n optical switch and n detectors.

Referring to FIG. 2, two devices are depicted on a graph of wavelength versus coupling ratio. These devices were designed to have the same coupling ratio by their manufacturer, yet using the apparatus shown in FIG. 1, it can be determined that, actually, the coupling ratios of the two devices are quite different. The high resolution is due to the insensitivity to losses and light source power variations, enabling smaller coupling ratio differences to be detected.

The coupling characteristics of many integrated optical devices are polarization sensitive, i.e., their coupling ratios may depend on the input polarization state. In many cases, the polarization state of the light present in optical systems is neither controlled nor stable, and many devices are designed to minimize their polarization dependence. In general, polarization dependence is an important property of most optical devices and therefore it is important to be able to accurately measure it in order to determine its effects in optical systems. The measurement method described above may be extended in order to determine the polarization dependence of the coupling coefficient of optical devices.

The measurement system shown in FIG. 4 includes a polarization controller 26 and two photo detectors 22. The polarization controller 26 is placed in between a laser source 24, optical switch 16, and device under test (DUT) 12. For measuring wavelength dependent coupling, either a wavelength tunable or broadband source may be used. The light power from the two coupled outputs is then directed to two photo detectors 22 simultaneously. In the case of a broadband source, an optical spectrum analyzer or tunable optical filter may be used at the detectors in order to measure wavelength dependence. With the source connected to input #1, the polarization dependent transmission through the device is measured by any one of several methods known in the art, e.g., the four-state Mueller method or direct polarization scanning or scrambling methods. In the Mueller method, four well-defined Mueller polarization states are generated by the controller 26 and the output signals are measured and recorded for each state. The source 24 is then switched to input #2 for the same polarization scans, without moving the output alignment. For wavelength-dependent measurements, one of several methods may be used—the wavelength may be scanned for each polarization state, the polarization states may be scanned for each wavelength, or both wavelength and polarization may be scanned simultaneously and asynchronously. The data (16 data points for a fixed wavelength measurement) collected from two detectors 22 for the two polarization scans are used to compute the polarization dependent coupling ratio (Δ) of the intrinsic device under test 12.

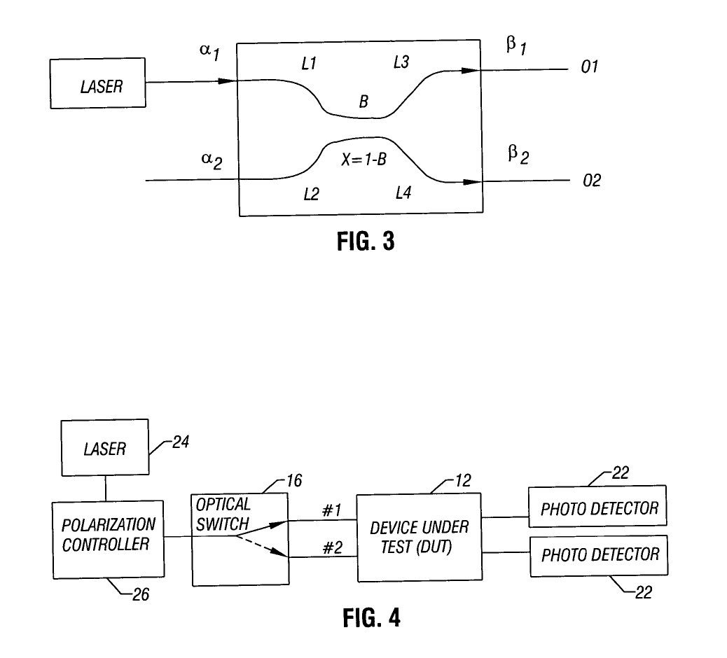

The minimum (Tmin) and maximum (Tmax) coupling ratios are computed from one of the polarization dependence measurements described above. For example, Mueller data from each output for input #1 and input #2 are measured independently as indicated in FIG. 3. Referring to FIG. 3, αᵢ and βᵢ represent the insertion losses from coupling the device to the source and detectors, respectively, Lᵢ represents the propagation losses in the waveguide regions indicated in FIG. 3, X is the coupling ratio in the coupler, and B is the fraction of power that remains uncoupled (equal to 1-X for no loss in the coupling region). In many cases, the device under test 12 exhibits birefringence. In planar optical devices, the birefringence has axes typically either parallel (TE) or perpendicular (TM) to the wafer surface. Therefore, Tmin and Tmax generally correspond to TE and TM polarization states. It is also known that the losses in the waveguide are TE and TM mode dependent, and waveguide bend and coupling are usually in-plane on a planar lightwave circuit chip. Therefore, the 2×2 transfer matrices for both B and X as well as waveguide bend loss Lᵢ(i=1,2,3,4) are typically diagonal in TE and TM modes, i.e., there is no change in polarization state during propagation through the device, and the loss and coupling axes are typically parallel to each other. Under these conditions, Tmax polarization on the output 1 corresponds to the Tmin polarization at the output 2 and vice versa. Combining these results, we can extract the polarization dependent coupling ratio of the intrinsic device. From FIG. 3 we can see the output 1 and output 2 powers are proportional to input power:

O₁=I₀α₁L₁BL₃β₁ O′₁=I₀α₂L₂XL₃β₁

O_{2=I}₀α₁L₁XL₄β₂ O′₂=I₀α₂L₂BL₄β₂

Oᵢ and O′ᵢ are the output powers corresponding to the source connected to input 1 and input 2, respectively. From these equations, we can compute the maximum and minimum effective coupling ratios as:

$${Δ}_{max} ≡ 10 log ( \frac{{B}_{max}}{{X}_{min}} ) = 5 log ( \frac{{O}_{1 , max} {O}_{2 , max}^{′}}{{O}_{2 , min} {O}_{1 , min}^{′}} )$$

$${Δ}_{min} ≡ 10 log ( \frac{{B}_{min}}{{X}_{max}} ) = 5 log ( \frac{{O}_{1 , min} {O}_{2 , min}^{′}}{{O}_{2 , max} {O}_{1 , max}^{′}} )$$

where the maximum and minimum of the output may be computed from the four Mueller states or by some other means as known in the art. Note that this definition of Δ corresponds to Δ<0 for over-coupling, Δ>0 for under-coupling, and Δ=0 for equal (50/50) coupling. Other conventions for Δ may be used without loss of generality of the conclusions. Note also that, under the conditions assumed above (i.e., the axes of the polarization dependent losses and polarization dependent coupling are parallel and no cross coupling of polarization states occurs), the polarization dependent loss from the input and output waveguide is canceled, as well as the fiber to the waveguide loss. In this way we obtain the true intrinsic coupling of the symmetric device. Since the TM mode is normally wider due to waveguide stress, the TM mode is slightly more coupled than the TE mode:

$${Δ}_{TE} ≡ 10 log ( \frac{{B}_{max}}{{X}_{min}} ) = 5 log ( \frac{{O}_{1 , max} {O}_{2 , max}^{′}}{{O}_{2 , min} {O}_{1 , min}^{′}} )$$

$${Δ}_{TM} ≡ 10 log ( \frac{{B}_{min}}{{X}_{max}} ) = 5 log ( \frac{{O}_{1 , min} {O}_{2 , min}^{′}}{{O}_{2 , max} {O}_{1 , max}^{′}} )$$

From the above formula, the intrinsic coupling ratio can be measured, at least partially, if not completely, removed from the error from polarization dependent coupling, fiber alignment uncertainty, and the polarization dependent losses from the waveguide that leads to and from the intrinsic device.

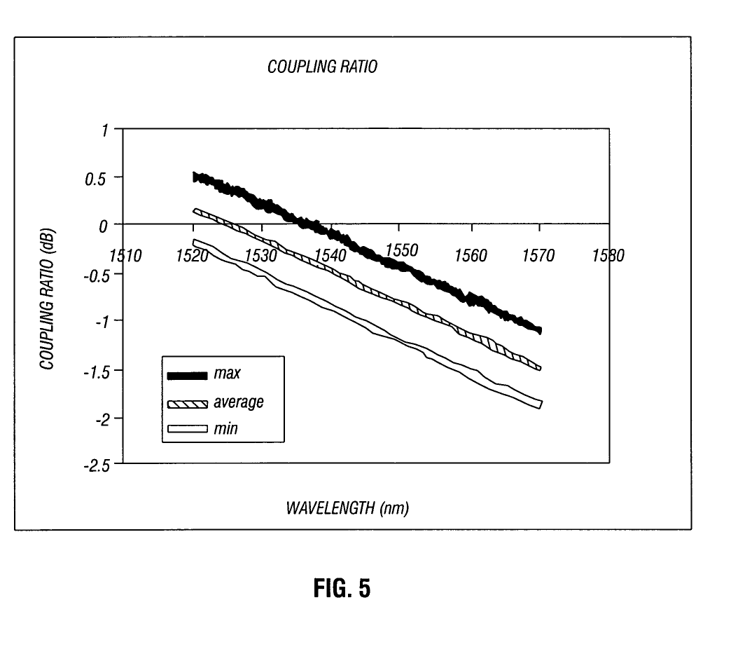

FIG. 5 shows a graph of coupling ratio versus wavelength measured by the technique described herein. For this device, the polarization dependent coupling ratio has a difference as large as 0.7 dB between the minimum and the maximum or the TE and TM modes. The random polarization light source can give any value in between the upper line and the lower line for coupling ratio, even if the other error sources have been eliminated. The coupling ratio is increasingly over coupled with the increase of wavelength due to the reduced confinement of the mode at longer wavelengths.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method of detecting a characteristic of an optical device having at least two optical inputs and two optical outputs comprising:
coupling a light source to said device through a switch which has at least one input and at least two outputs, the at least two outputs of said switch being coupled to the two inputs of said device; and
coupling each of the two outputs of said device to a different detector.

2. The method of claim 1 including coupling said light source to said switch through a polarization controller.

3. The method of claim 2 including coupling said light source to said optical switch through a polarization controller that generates the four Mueller polarization states.

4. The method of claim 1 including scanning the four Mueller polarization states to the first input and detecting both outputs of said device.

5. The method of claim 4 including after scanning the four polarization states to the first input and both outputs, scanning the four polarization states to the second input and detecting both outputs.

6. The method of claim 1 including providing a light output to said detectors simultaneously.

7. A test apparatus for detecting a characteristic of an optical device having at least two optical inputs and two optical outputs, said apparatus comprising:
a light source;
a 1× at least 2 optical switch coupled to receive light from said light source, said optical switch having at least two outputs coupled to said at least two optical inputs of said device; and
at least two photo detectors each of which is coupled to a different one of said at least two optical outputs.

8. The apparatus of claim 7 including a polarization controller coupled between said light source and said optical switch.

9. The apparatus of claim 8 wherein said polarization controller successively generates the four Mueller polarization states.

10. The apparatus of claim 8 wherein said optical switch provides a signal to a first optical input of said device and outputs are detected at each of said photo detectors simultaneously.

11. A method comprising:
providing a light source to a polarization controller;
generating different polarization states from said polarization controller;
successively providing said polarization states to a first input port of a device under test;
simultaneously providing outputs from said device under test to at least two different photodetectors; and
thereafter successively providing different polarization states to a second input port of said device under test and simultaneously detecting output signals from two different output ports of said device under test.

12. The method of claim 11 including generating the four Mueller polarization states.

13. The method of claim 11 including providing a 1× at least 2 optical switch between said polarization controller and the at least two input ports of said device under test.

14. An optical measurement system comprising:
a light source;
a polarization controller to produce different polarization states;
at least two photodetectors; and
an element to successively provide different polarization states to a first input port of a device under test and to simultaneously provide outputs from said device under test to said photodetectors and to thereafter successively provide different polarization states to a second input port of a device under test and simultaneously detect output signals from two different output ports of said device under test.

15. The system of claim 14 wherein said controller is a Mueller polarization state generating controller.

16. The system of claim 15 wherein said element includes a 1× at least 2 optical switch.

17. An optical measurement system comprising:
a light source;
a polarization controller coupled to said light source to produce at least four Mueller polarization states;
a 1× at least 2 optical switch coupled to the output of said polarization controller and connectable to at least two input ports of a device under test; and
at least two photo detectors connectable to different ones of at least two output ports of a device under test.

18. The system of claim 17 wherein said first and second photo detectors are arranged to simultaneously detect outputs from said device.

19. The system of claim 18 wherein said controller is set to successively generate said four Mueller polarization states.
